(19) United States
(12) Patent Application Publication
(10) Pub. No.: US 2003/0046377 A1
(43) Pub. Date: Mar. 6, 2003

(54) Method and apparatus for appliance service diagnostics

(76) Inventors: Wolfgang Daum, Erie, PA (US); John Steven Holmes, Sellersburg, IN (US); William Hull Bicknell, Louisville, KY (US); Scott Allen Horning, Louisville, KY (US); Tanveer Iqbal, Louisville, KY (US); Scott Charles Evans, Burnt Hills, NY (US)

Correspondence Address: John S. Beulick, Armstrong Teasdale LLP, Suite 2600, One Metropolitan Square, St. Louis, MO, 63102, US

(21) Appl. No.: 09/748,440

(22) Filed: Dec. 27, 2000

(51) Int. Cl. G06F 15/173

(52) U.S. Cl. 709/223

(57) ABSTRACT

A method and apparatus for service diagnostics of appliances includes connecting to a local area appliance network, accessing an appliance in the local area appliance network, accessing functions of the appliance, and performing service diagnosis of the appliance using the functions. A diagnostic interface is used to diagnose and service the appliance. The local area appliance network may be a power line carrier communication carrier network. The diagnostic interface may connect to a remote system for service diagnostic information.

### BACKGROUND OF THE INVENTION

The preferred embodiments of the present invention generally relate to service diagnostics, and in particular relate to a method and apparatus for performing service diagnostics on appliances.

The typical home, office building, or commercial establishment contains several appliances, including refrigerators, microwave ovens, ovens, stoves, heating systems, cooling systems, and the like. Modern appliances are much more sophisticated than their early counterparts, and often include microcontrollers or microprocessors that allow the appliance to be programmed, reprogrammed, and provide diagnostic information, as examples.

Appliances in homes and other buildings often experience problems that require diagnosis and repair by a service technician. Service technicians must often use complex equipment and methods (that may also be inefficient and inaccurate) to perform service diagnostics on the appliances. Additionally, current manually performed service diagnostics often require the service technician to move and/or dismantle the appliance to locate the problem.

The Internet has given rise to worldwide connectivity for many types of devices. Appliances, however, only have traditional standalone capability. Three primary communication technologies may be used to provide appliance connectivity: hard wiring, power line carrier (PLC), and wireless.

Hard wiring (including for example RS-232, RS485, Ethernet, USB, HomePNA, and industrial twisted pair networks) offers superior performance capability (when measured in terms of speed, noise immunity, and the like) at an effective cost. However, a drawback is that additional wiring is required to a home or business. Hard wiring thus poses the significant problem of retrofitting networked appliances into existing homes and businesses and increases cost for new structures.

PLC uses a 120V or 240V AC power line as a carrier for networking data by modulating the networking data on a high frequency carrier. The high frequency carrier is usually between 100-400 kHz to keep it below the range of FCC regulation. Although older technologies, such as X10, have achieved some market acceptance in lighting applications, they are generally deemed too slow and unreliable for major appliance networking needs. However, newer PLC technologies, such as CEBus and LonWorks, are now commercially available and provide improved data rates and noise immunity at reasonable cost.

Wireless technologies (such as IEEE 802.11, Bluetooth, HomeRF, and the like) solve the problem of additional wiring by modulating data onto a radio frequency carrier (e.g., at 2.4 GHz) that is broadcast via antenna to desired recipients. Wireless approaches may offer higher bandwidth than PLC technologies currently available, but they do so at a higher cost. Furthermore, since most major appliances are packaged in a sheet steel enclosure (which makes an effective RF shield), antenna placement may be difficult. Cost effective wireless technologies are also subject to distance limitations, potential interference, and poor reception zones that can often render their use in the home with large, immobile appliances impossible.

As noted above, the intense manual labor involved in prior appliance diagnosis was unduly wasteful. Nevertheless, it was not previously possible to perform appliance diagnosis using, for example, the any of the physical network media identified above.

A need has long existed for a method and apparatus for appliance diagnosis that overcomes the problems noted above and other previously experienced.

### BRIEF SUMMARY OF THE INVENTION

A preferred embodiment of the present invention provides a method of performing service diagnostics on appliances. The method comprises connecting to a local area appliance network, accessing an appliance in the local area appliance network, accessing functions of the appliance, and performing service diagnosis of the appliance using the functions. In a preferred embodiment, the local area appliance network is a power line carrier communication carrier network.

A preferred embodiment of the present invention also provides a diagnostic interface for performing service diagnostics on appliances. The diagnostic interface comprises a display for viewing diagnostic and service information, processing circuitry, and a power line carrier communication interface for transmitting and receiving data on a power line carrier communication system. The diagnostic interface may also include an appliance bus interface and a PC card interface. The diagnostic interface may also connect to a remote system for service diagnostic information.

An additional preferred embodiment of the present invention provides a system for performing service diagnostics on an appliance. The system comprises a diagnostic interface for performing service diagnostics on the appliance, a local area appliance network, the network allowing access to the appliance, and a dedicated appliance controller. In a preferred embodiment, the local area appliance network comprises a power line carrier network. In a preferred embodiment, the dedicated appliance controller is contained in the appliance. The system may also include a remote system and an Internet connection between the diagnostic interface and the remote system.

### BRIEF DESCRIPTION OF THE DRAWINGS

FIG. 1 illustrates a system for performing service diagnostics on appliances.

FIG. 2 depicts an implementation of a diagnostic interface for performing service diagnostics on appliances.

FIG. 3 presents a method for performing service diagnostics on appliances.

FIG. 4 shows a flow diagram of a method for translating between a power line carrier communication protocol and an appliance communication protocol.

FIG. 5 shows a software flow diagram for diagnosing and servicing appliances.

FIG. 6 illustrates a diagnostics system that interfaces through a power line to an appliance.

FIG. 7 shows a communications interface between an appliance and a power line carrier communication system.

FIG. 8 shows a dedicated appliance controller.

### DETAILED DESCRIPTION OF THE INVENTION

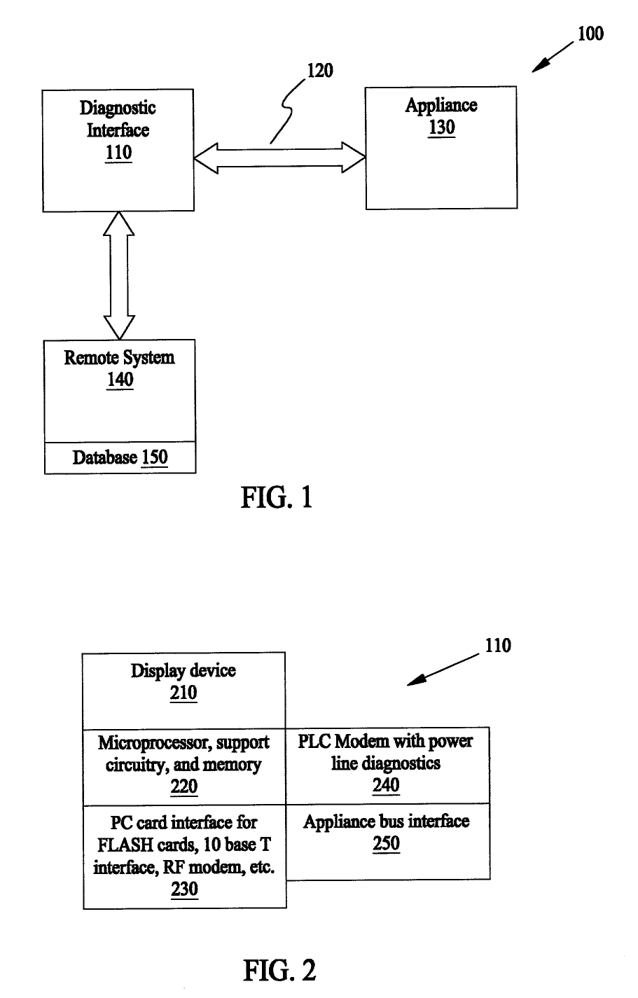

FIG. 1 illustrates a service diagnostic system 100 for performing service diagnostics on appliances. The service diagnostics system 100 includes a diagnostic interface 110, a local area network connection 120, an appliance 130, and a remote system 140. Preferably, the local area network connection 120 is implemented as a power line carrier connection. The appliance 130 may be, as examples, a refrigerator, microwave oven, convection oven, stove, heating system, cooling system, lighting system, and the like. The remote system 140 may be a remote service center and may maintain a database 150 of appliance diagnosis information, stored by appliance type and serial number, for example.

FIG. 2 depicts an implementation of the diagnostic interface 110 for performing service diagnostics on the appliance 130. The diagnostic interface 110 includes a display device 210, a microprocessor or processing circuitry 220, a PC card (or other expansion bus) interface 230, a power line carrier modem 240, and an appliance bus interface 250. The diagnostic interface 110 may be implemented in a computer (e.g., a laptop computer), by adding the requisite hardware in expansion slots, for example. Alternatively, the diagnostic interface 110 may be implemented as a dedicated stand-alone service tool.

The display device 210 may be implemented as a liquid crystal display (LCD), a CRT monitor, or an LED display. The display device 210 allows the service technician to view diagnostic results, appliance 130 status, and the like.

The microprocessor 220 may be implemented, for example, as a Hitachi H8-3644 microprocessor. The microprocessor 220 transmits service commands to a dedicated appliance controller in the appliance 130 and gathers statistics on the appliance 130. The microprocessor 220 may also include a memory and support circuitry to facilitate diagnosis and servicing of the appliance 130.

The PC card interface 230 allows PC cards to be connected to the diagnostic interface 110. PC cards connected to the diagnostic interface 110 may include a FLASH memory card (for additional program memory), a 10 base T interface card (for ethernet connection), a RF modem card (for wireless communication), and the like. Expansion cards thereby allow the diagnostic interface 110 to communicate with the remote system 140 (such as a remote service center) to receive programs, diagnostic routines, upgrade messages, and the like.

The power line carrier modem 240 may be implemented as a X10 compliant module as provided at www.x10.com, a CEBUS compliant module as provided by Domosys, and the like. The power line carrier modem 240 allows the diagnostic interface 10 to communicate with an appliance 130 via a power line carrier system in which service commands are transmitted by modulating the data on a high frequency carrier above the power line carrier. In a preferred embodiment, the modulated data is a sinusoid wave that is transmitted along with AC power through the power lines. The high frequency carrier is usually between 100-400 kHz to keep it below the range of FCC regulation

The appliance bus interface 250 may be implemented as a serial bus interface. The appliance bus interface 250 allows the diagnostic interface 110 to connect directly with the appliance bus and communicate with the dedicated appliance controller, in the event that the appliance provides such a direct connection.

In a preferred embodiment, at least certain aspects of a serial communication bus are implemented when communicating between two or more microcontrollers, or other devices distributed among one or more platforms (e.g., an appliance and a communications interface). The serial communications bus is preferably a single line bus comprising a physical layer, a data-link layer, and an application layer. The serial communication bus allows on demand communications in a multi-master environment. The multi-master environment allows any device in the system to request information or actions from any other device in the system at any time once the device successfully attains bus control through arbitration.

The serial communication bus standard uses a collision detection technique to determine when a communications port is free or in use and when a collision has occurred. A collision occurs when two or more masters attempt to use the communications bus at the same time. A collision may be detected since the transmit and receive ports on the microcontroller 245 are connected to the same bus wire. Control of interrupts associated with the communications port allows collision detection to be an interrupt driven activity. The protocol used is a byte-oriented protocol. A higher level protocol determines the length and content of packets comprising messages. The following state table (Table 1) describes the relevant function of the serial communication protocol.

TABLE 1
Physical Communication Protocol State Table

| State | Action | Result | Next State |
|---|---|---|---|
| 1 | Are there bytes to send? | Yes | 2 |
| | | No | 1 |
| 2 | Check bus activity | Busy | 6 |
| | | Free | 3 |
| 3 | Send Byte | | 4 |
| 4 | Does byte sent = byte received? | Yes | 1 |
| | | No | 5 |
| 5 | Delay 3 to 8 byte times | Complete | 1 |
| 6 | Delay 5 byte times | Complete | 1 |

In the two delay states, 5 and 6, a byte time is defined as the amount of time required to transmit a single byte on the communications bus. The byte time is determined by the baud rate, number of data bits, number of stop bits, and a parity bit, if used.

The variable delay period shown in state five is intended to make the restart delay time random. If a collision does occur, the two bus masters preferably do not delay the same amount of time before retrying transmission. The variable delay may reduce the possibility of subsequent collisions by the two masters. The variable delay period may be determined by a pseudo random number process, or by a board function.

The data-link layer defines information that moves across the bus in any given packet of data. The bytes defined in the data-link layer do not necessarily have a one to one correlation with the bytes in the physical layer. Many physical devices have bits in the physical layer that implement the functions of some of the bytes in the data-link layer. The data-link layer may be designed so that the data-link layer and the application layer may not need to change even if the physical device is redesigned. The data-link layer of the communication system is appropriate for such technologies as UART multi-drop environment.

The protocol may be used in a master/slave environment. The system may have at least one master and at least one slave. The protocol may be implemented in a small network environment where one device can be a master through one communication cycle and then become a slave for another communication cycle.

A command is used by a master device to request action from a slave. A command packet of data may be structured as follows in Table 2 (note that the number of bytes may vary depending on need):

TABLE 2
Command Data Packet

| | | Packet | | | | |
|---|---|---|---|---|---|---|
| STX | Address | Length | Command | Data | CRC | ETX |
| 1 byte | 1 byte | 1 byte | 1 byte | N bytes | 2 bytes | 1 byte |

where, in a preferred embodiment:

STX (start transmission) is one byte with a value of 0×02. To determine whether an STX is valid, the protocol checks whether an ACK (acknowledgment) byte follows and if yes, the 0×02 is in the middle of a transmission and should not be interpreted as an STX;

Address is one byte and each device has one effective address;

Packet Length is the number of bytes in the packet including STX, Address, Packet Length, Command, Data, CRC, and ETX. The packet length value is 7−n, where n is the number of data bytes;

Command is one byte defined by the application layer,

Data may be zero, one, or multiple bytes as defined in the application layer, except for the case of a request in which the first data byte will be the master's address so the slave will know which device to respond to;

CRC (cyclic redundancy code) is a 16-bit CRC. The CRC is computed on all bytes of a packet except the STX, the CRC byte pair and the ETX; and

ETX (end transmission) is one byte with a value of 0×03.

The protocol, including ACKs, is given in Tables 1-3. At any point in the process where an ACK can be sent a NAK (no acknowledgment) may be sent instead. If a NAK is transmitted, the communication sequence is aborted at that point. The master then has an option of re-starting the sequence (application dependent). A NAK is preferably transmitted in response to a received ETX when the computed packet CRC does not match the transmitted packet CRC. An additional ACK is sent at the end of each packet.

In a preferred embodiment, an ACK is one byte with a value of 0×06.

In a preferred embodiment, a NAK is one byte with a value of 0×15.

Tables 3-5 assume that time increments with each row of the table. Up to hundreds of milliseconds of delay may be tolerated for any expected event, such as, an ACK response to a transmitted byte, or the reception of the next byte of an incomplete packet. The arrow indicates the data direction. For the request sequence and response to request sequence, the first data byte is the transmitter's address.

TABLE 3
Command Sequence
Command Sequence

| | |
|---|---|
| Master | Slave |

| | | | |
|---|---|---|---|
| STX → | [0×02] | | |
| Slave Address → | 1 byte | | |
| | | [0×06] | ← ACK |
| Packet Length → | 1 byte | | |
| | | [0×06] | ← ACK |
| Command → | 1 byte | | |
| | | [0×06] | ← ACK |
| Data Byte 1 → | 1 byte | | |
| | | [0×06] | ← ACK |
| Data Byte 2 → | 1 byte | | |
| | | [0×06] | ← ACK |
| Data Byte n → | 1 byte | | |
| | | [0×06] | ← ACK |
| CRC MSB → | 1 byte | | |
| | | [0×06] | ← ACK |
| CRC LSB → | 1 byte | | |
| | | [0×06] | ← ACK |
| ETX → | [0×03] | | |
| | | [0×06] | ← ACK |
| | | [0×06] | ← ACK |

TABLE 4
Request Sequence
Request Sequence

| | |
|---|---|
| Requestor | Requestee |

| | | | |
|---|---|---|---|
| STX → | [0×02] | | |
| Request Address → | 1 byte | | |
| | | [0×06] | ← ACK |
| Packet Length → | 1 byte | | |
| | | [0×06] | ← ACK |
| Request Command → | 1 byte | | |
| | | [0×06] | ← ACK |
| Data Byte - | 1 byte | | |
| Requestor's Address | | | |
| (Transmitter) → | | | |
| | | [0×06] | ← ACK |
| Data Byte 2 → | 1 byte | | |
| | | [0×06] | ← ACK |
| Data Byte n → | 1 byte | | |
| | | [0×06] | ← ACK |
| CRC MSB → | 1 byte | | |
| | | [0×06] | ← ACK |
| CRC LSB → | 1 byte | | |
| | | [0×06] | ← ACK |
| ETX → | [0×03] | | |
| | | [0×06] | ← ACK |
| | | [0×06] | ← ACK |

TABLE 5
Response to Request Sequence
Response to Request Sequence

| | |
|---|---|
| Requestee | Requestor |

| | | | |
|---|---|---|---|
| STX → | [0×02] | | |
| Requestor's Address → | 1 byte | | |
| | | [0×06] | ← ACK |
| Packet Length → | 1 byte | | |
| | | [0×06] | ← ACK |
| Command to which | 1 byte | | |
| Requestee is | | | |
| Responding → | | | |
| | | [0×06] | ← ACK |
| Data Byte 1 - | 1 byte | | |
| Requestee's Address | | | |
| (Transmitter) → | | | |
| | | [0×06] | ← ACK |
| Data Byte 2 → | 1 byte | | |
| | | [0×06] | ← ACK |
| Data Byte n → | 1 byte | | |
| | | [0×06] | ← ACK |
| CRC MSB → | 1 byte | | |
| | | [0×06] | ← ACK |
| CRC LSB → | 1 byte | | |
| | | [0×06] | ← ACK |
| ETX → | [0×03] | | |
| | | [0×06] | ← ACK |
| | | [0×06] | ← ACK |

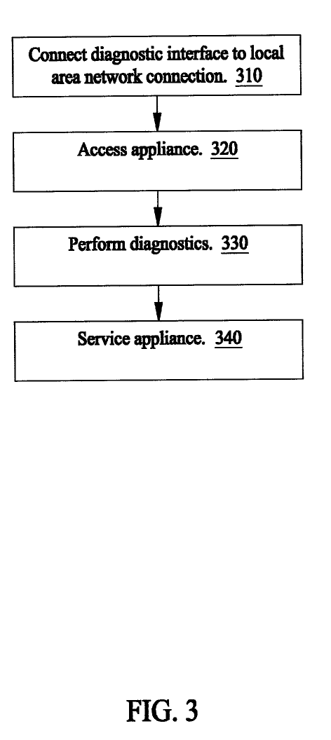

FIG. 3 presents a method for performing service diagnostics on appliances. In step 310, a service technician connects the diagnostic interface 110 to a local area network connection 120 (e.g., the AC power lines) within the building housing the appliance 130. At step 320, the diagnostic interface 110 accesses the appliance 130 for diagnosis. Preferably, the diagnostic interface 110 directly accesses the controller in the appliance 130. In an alternative embodiment, the diagnostic interface 100 may access the appliance 130 controller via an intermediate interface (such as an interface that translates between a power line carrier communication protocol and an appliance communication protocol). Preferably, the diagnostic interface 110 may access a superuser level of functions in the appliance 130.

The superuser level of functions, also known as service functions, includes appliance safety functions, appliance parameter functions, appliance status functions, and the like. The superuser level of functions includes, as examples, activating and deactivating the specific loads such as heaters, compressors, motors, relays, solenoids, interlocks, user interfaces, and the like. The superuser level of functions allows the diagnostic interface 110 to diagnose and service the appliance 130 efficiently and more effectively than traditional methods of service.

At step 330, the diagnostic interface 110 performs diagnostics on the appliance 130. Preferably, the service technician initiates diagnostics using the diagnostic interface 110. In an alternative embodiment, the diagnostic interface 110 may automatically perform a sequence of diagnostics operations based on appliance type. The diagnostic interface 110 may perform operations including turn heaters on and off, turn fans on and off, trigger appliance specific devices, test user interfaces, check safety devices, and the like. Operations may also include test appliance subsystems, test refrigeration, test cleanliness, test filter status, test self-cleaning status, test refrigerator defrost operation, test cooktop heater operation, test heater pan presence operation, test washer motor operation, and the like. The diagnostic interface 110 may gather statistics returned by the appliance regarding system run time, duty cycle, amount of time out of heat regulation, power consumption, temperature characteristics, memory checksums, system upgrade population distribution, usage population distribution, supply voltage distribution, supply outage distribution, supply over voltage distribution, and the like.

At step 340, the diagnostic interface 110 may service the appliance 130 to correct problems that may have been discovered in performing diagnostics. The diagnostic interface 100 may service the appliance 130 by adjusting characteristics including fan speeds, hysteresis limits, on times, off times, power levels, and the like, using appliance commands that adjust those characteristics.

The diagnostic interface 110 may, for example, be implemented as a graphical user interface (GUI) that allows the service technician to use the capabilities of the diagnostic interface 110 to diagnose and service the appliance 130. The GUI may be implemented as a Windows, Windows CE, Unix etc. based program that includes icons and pull down menus allowing the service technician to access, control, store and display all of the functions. The GUI allows for the display and manipulation of diagnostics data.

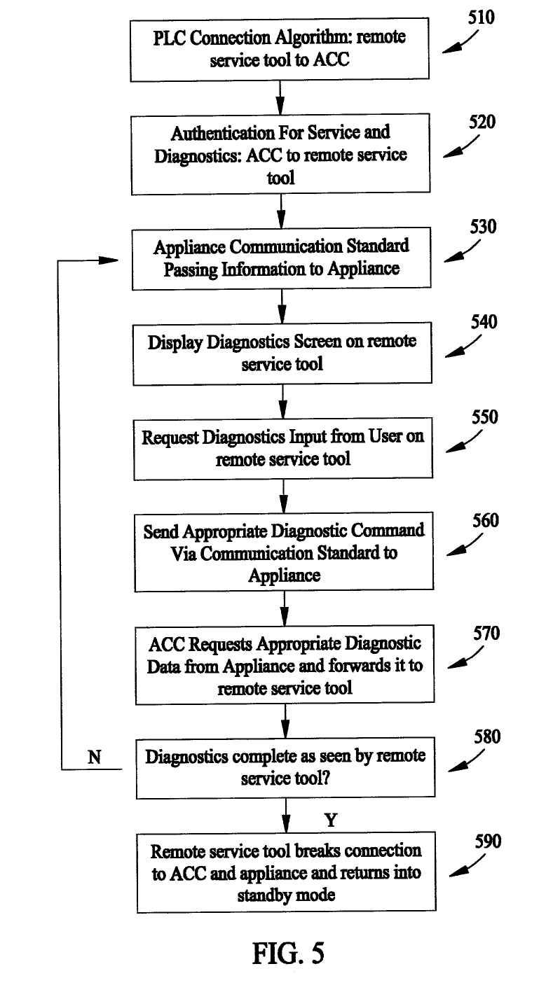

Through the GUI, the service technician accesses diagnostic software on the diagnostic interface 110. The diagnostic software enables access to superuser level functions in the appliance 130 and formulates commands and updates for the appliance 130 and the appliance's dedicated appliance controller. FIG. 5 shows a flow diagram of the software for diagnosing and servicing the appliance 130. The PLC Connection Algorithm 510 establishes the connection of the PLC to the communication interface 700 or to an Appliance Communication Controller (ACC). The ACC is described in detail in G.E. Docket No. 9d-hr-19457, titled “RECONFIGURABLE APPLIANCE CONTROL SYSTEM”, filed ______ as serial No. ______ and is incorporated herein by reference in its entirety. The PLC Connection Algorithm can be implemented as a software module that requests information as is disclosed in the incorporated application. The Authentication For Service and Diagnostics module 520 takes the information passed by the PLC Connection Algorithm 510 and performs the required authentication and validation to ensure that only authorized access is given to the diagnostics mode. The module can be implemented in software as more fully disclosed in the incorporated application. Once authentication has been obtained information is passed to the appliance as well as returned from the appliance to the ACC using the Appliance Communication 530 as more fully described above in Tables 1-5. It is understood that subsequent information flow between the remote service tool and the appliance passes through the ACC and is bi-directional in nature as more fully disclosed in the incorporated application. The Display Diagnostics Screen 540 on remote service tool shows the diagnostics options to the service provider. It is understood that the remote service tool (not shown) can be a portable computer such as a Dell Latitude series computer, running Windows, a PDA such as a Windows CE computer as manufactured by Toshiba, a stationary computer such as a Hewlett Packard Vectra SE series computer and the like running Windows, Windows CE, Unix, or another operating system. The Request Diagnostics Input from User module 550 then requests diagnostics information from the user on the remote service tool. Once the information has been entered on the remote service tool, the Send Appropriate Diagnostic Command Via Communication Standard to Appliance module 560 forwards the appropriate command to the appliance for action. This module can be implemented as a software module on the remote service tool. The ACC Requests Appropriate Diagnostic Data from Appliance module 570 requests performance and diagnostics data from the appliance and forwards it to remote service tool. This module can be implemented in the ACC as more fully disclosed the incorporated application. The Diagnostics Complete module 580 tests whether the diagnostics has been completed and no further information is requested by the user. It can be implemented as a software module on the remote service tool. In case further diagnostics is required or requested, control on the remote service tool is returned to the Appliance Communication Standard Passing Information to Appliance module 530. In case the diagnostics operation is complete, control is given to the Remote Service Tool Breaks Connection to ACC and Appliance and Returns into Standby Mode module 590, that breaks the connection to the ACC and appliance and then returns the remote service tool into its standby mode after having saved all relevant information.

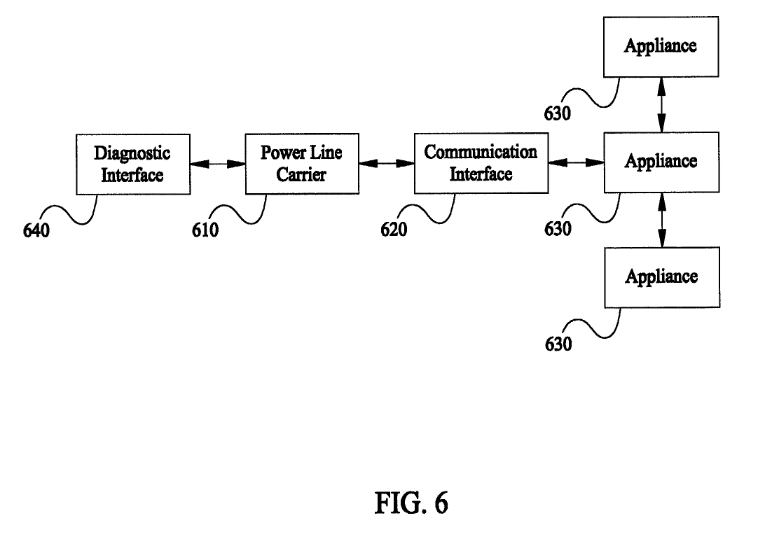

In an alternative embodiment, the power line carrier modem 240 may be implemented as a communication interface between a power line carrier communication system and an appliance communication system. FIG. 6 illustrates an appliance communication system 600 for connecting a power line carrier and an appliance. The communication system 600 includes a communications interface 620 that provides for bidirectional transmission of data between a power line carrier (PLC) 610 and at least one appliance 630. The appliance 630 may be, as examples, a refrigerator, microwave oven, convection oven, stove, heating system, or cooling system. The PLC 610 may be, as examples, 120 volt (120V) AC (alternating current) power or 240 volt (240V) AC power. As shown, the diagnostic interface 640 connects to the appliances 630 through the PLC 610 and communication interface 620.

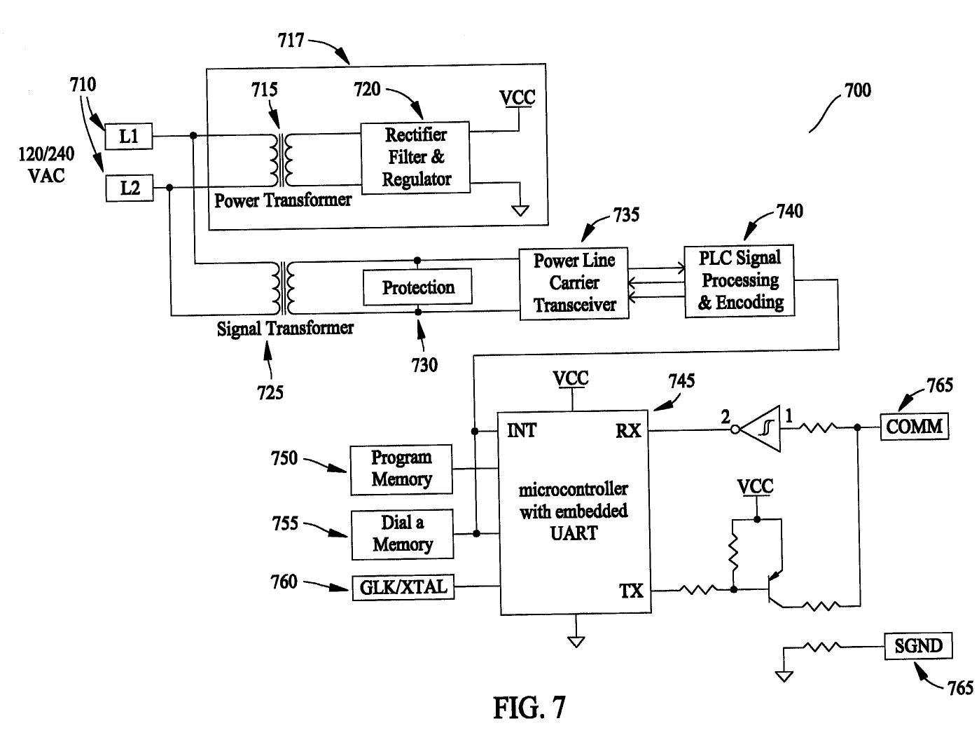

A detailed diagram of the communications interface 620 is shown in FIG. 7. In particular, FIG. 7 shows a communications interface 700 between an appliance and a power line carrier communication system. The communications interface 700 comprises two connections 710 for 120V or 240V AC power lines. The communications interface 700 also includes a transformer based power supply 717. As shown, the transformer based power supply 717 comprises a transformer 715 and a rectifier, filter and regulator 720. The communications interface 700 also includes a signal transformer 725 and protector 730. The communications interface 700 further includes a power line carrier (PLC) transceiver 735 and a PLC signal processing and encoding unit 740 (PLC signal processor). The communications interface 700 includes a microcontroller 745. The communications interface 700 may also include a program memory 750, a data memory 755, and a clock 760. The communications interface 700 further comprises connections 765 for appliance communication. In a preferred embodiment, one of the connections is a signal (COMM) connection and the other connection is signal ground (SGND) connection.

The transformer 715 may be implemented as implemented as standard power transformer such as that manufactured by Signal. The rectifier, filter and regulator 720 may be implemented as a Texas Instruments 1N4004, filter capacitors such as Rubicon 4700 uF capacitors and a Toshiba 78M05 regulator. The signal transformer 725 may be implemented as a toroidal signal transformer such as that made by Signal. The protector 730 may be implemented as a gas tube as manufactured by Siemens, for example. The PLC transceiver 735 and encoding unit 740 may be implemented using integrated circuits available, for example, from Phillips. The microcontroller 745 may be a be a Hitachi H8-3644, for example.

In a preferred embodiment, the communications interface 700 comprises four connections 710, 765. Two connections 710 couple to an AC power line (e.g., 120V or 240V) that provides a power line carrier channel. A transformer based power supply 717 is connected to the connections 710. The transformer based power supply 717 includes a power transformer 715 and a rectifier, filter and regulator 720 and generates logic level supplies for electronic signal processing and logic. The transformer based power supply 717 also provides electrical isolation of electronic signal processing and logic from the AC power line. Alternative embodiments may use galvanically isolated switching power supplies or low cost resistive or capacitive dropping power supplies that provide lesser amounts of electrical isolation.

The connections 710 also connect to a signal transformer 725. The signal transformer 725 couples a modulated carrier frequency signal from the connections 710 to a PLC transceiver 735. A line protector 730 provides electrical isolation of the rest of the system from the AC line. Preferably, the line protector 730 is located between the signal transformer 725 and the PLC transceiver 735. Transmission between the PLC transceiver 735 and the PLC signal processor 740 is generally bidirectional, but may be unidirectional in certain applications.

The output of the PLC signal processor 740 feeds a microcontroller 745. The microcontroller 745 may be, for example, an embedded microcontroller. In an alternative embodiment, the PLC signal processor 740 and the microcontroller 745 may comprise a single device. In an alternative embodiment, the PLC signal processor 740 and the microcontroller 745 may be separate devices. Preferably, the microcontroller 745 includes a general purpose universal asynchronous receiver transmitter (UART) that communicates with the appliance through a communications channel connected by the connections 765. In a preferred embodiment, the UART establishes bidirectional communication with the appliance communications channel, for example, by disabling the transmitter to a high impedance state when not transmitting.

The microcontroller 745 generally includes a program memory 750 that stores instructions for execution by the processor. The microcontroller 745 may also include a data memory 755 that, for example, buffers messages. The program memory 750 and data memory 755 may work together to buffer messages and translate between a power line carrier communication protocol and an appliance protocol.

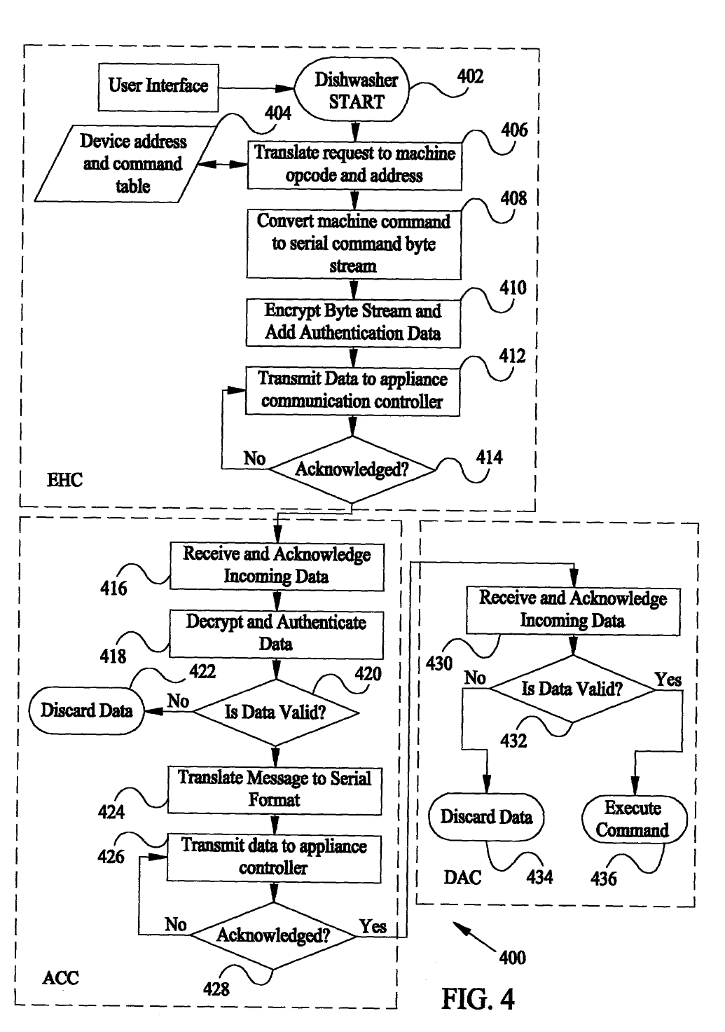

FIG. 4 shows a flow diagram of a method for translating between a power line carrier communication protocol and an appliance communication protocol in the communication interface 700. In a the exemplary embodiment, the user runs a service application on the diagnostic interface 640 that has been developed to manipulate the appliances within the home. In an alternative embodiment the service application may run on a remote system that has a communications link to the diagnostic interface 640. The user selects the appropriate command (e.g., Dishwasher START) 402 within the service application. The diagnostic interface 640, through the service application, will then interpret the command and obtain the machine specific command from the device information table 404. Once the appropriate command has been obtained (406) from the table 404, the diagnostic interface 640 will generate (408) a message packet including the machine command, and device address. The diagnostic interface 640 will further apply authentication data and encrypt (410) the data prior to transmission of the information to the communication interface 700. The diagnostic interface 640 converts the encrypted data to electrical signals and transmits (412) the electrical signals via the PLC 610. The diagnostic interface 640 will monitor (414) the transmission of the data packet to the communication interface 700 looking for an acknowledgment that the data was received correctly. If the acknowledgment is not received, the data will be retransmitted by the diagnostic interface 640.

In the preferred embodiment, the communication interface 700 accepts and acknowledges (416) the incoming data transmission from the diagnostic interface 640. In doing so, the electrical signals will be converted back to a logical data packet. The communication interface 700 will then employ the appropriate algorithms to decrypt (418) and authenticate (420) the received data packet. When the communication interface 700 is not able to authenticate the data packet, or finds the data packet to be invalid, the data packet will be discarded (422) and a retransmit request sent back to the diagnostic interface 640. Following a successful authentication of a data packet by the communication interface 700, the communication interface 700 will reformat (424) the data into a serial bus format. The data will them converted to electrical signals to be transmitted (426) via the serial bus. The communication interface 700 will monitor (428) the transmission of the data packet to the appliance (and preferably to a dedicated appliance controller running the appliance) and monitor for an acknowledgment of the data being received correctly.

At the receiving end of the communication line, the appliance will convert (430) the electrical signals from the communication interface 700 to logical information. Once the appliance has accepted the logical signals and has confirmed (432) the validity of the data, an acknowledgement will be transmitted back to the communication interface 700 to complete the data exchange. The appliance will then interpret the data within the data packet. If the data contains a valid command then the appliance will execute (436) the machine command accordingly. If the command is determined not to be valid then the request is discarded (434).

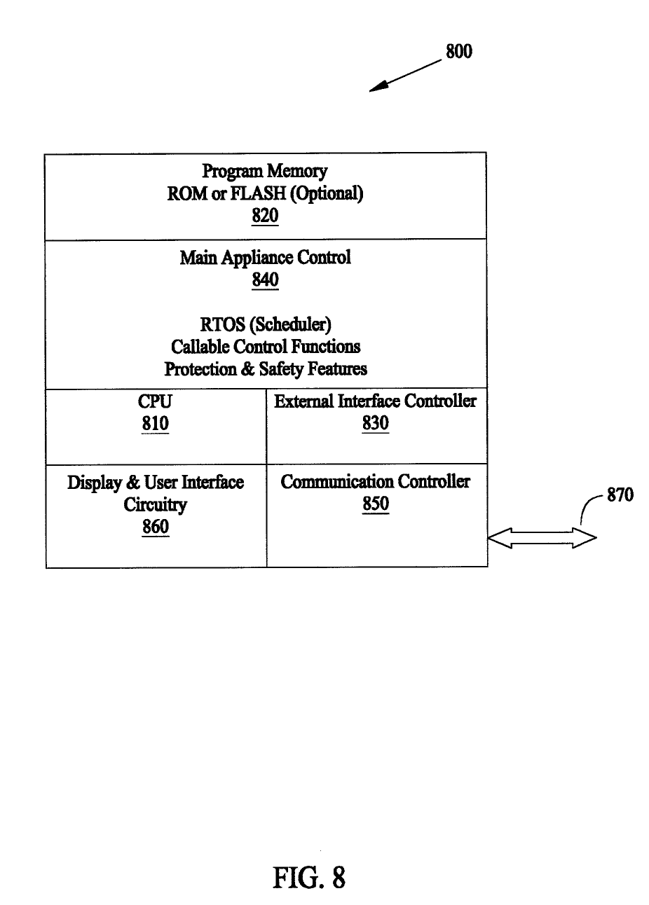

FIG. 8 shows an example of a dedicated appliance controller (DAC) 800 that may be present in an appliance. The DAC 800 includes a central processing unit (CPU) 810, local memory 820 RAM (random access memory) and ROM (read-only memory) (optionally implemented as reprogrammable FLASH memory), at least one external interface controller 830 (e.g., connected to appliance relays, sensors, and the like), and an application program 840. The external interface 830 provides a means to interface to other semi-autonomous sub-systems (e.g., a variable speed drive) present in an appliance. The application program 840 includes a scheduler, callable control functions, and protection and safety features. The application program 840 provides for the fundamental appliance specific operation such as cooking timing, wash cycle operation, and the like.

The DAC 800 may also accept modifications to its operating functions and algorithms by reprogramming the DAC 800 software 840. With the addition of a communication interface controller 850, the DAC 800 may be reprogrammed or directed to perform specific functions via commands through the command interface 850. The DAC 800 also includes display and user input circuitry 860. The display and user input circuitry 860 provides for user interaction and operation of the appliance such as setting the appliance clock, selection of cycles and the like. The DAC 800 communicates with the communication interface 700 via a communication link 870 (e.g., a serial communication bus

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of performing service diagnostics on appliances, the method comprising:
connecting to a local area appliance network;
accessing an appliance in the local area appliance network; and
performing service diagnosis of the appliance over the local area appliance network using service functions in the appliance.

2. The method of claim 1 wherein the local area appliance network comprises a power line carrier system.

3. The method of claim 1 wherein accessing further comprises accessing a dedicated appliance controller in an appliance.

4. The method of claim 1 wherein the service functions comprise safety functions.

5. The method of claim 1 wherein the service functions comprise appliance parameter functions.

6. The method of claim 1 wherein the service functions comprise appliance status functions.

7. The method of claim 1 further comprising connecting to a remote system to retrieve service diagnostic information.

8. The method of claim 1 wherein performing service diagnosis includes diagnosing and servicing the appliance based on the appliance diagnosis.

9. The method of claim 8 wherein servicing the appliance comprises patching appliance firmware.

10. The method of claim 8 wherein servicing the appliance comprises adjusting appliance parameters.

11. The method of claim 1 further comprising maintaining an external database of appliance information based on diagnosis of the appliance.

12. A diagnostic interface for performing service diagnostics on appliances, the diagnostic interface comprising:
a display for viewing diagnostic and service information;
processing circuitry for generating service commands for an appliance; and
a power line carrier communication interface for transmitting the service commands to the appliance and receiving appliance diagnostic results on a power line carrier communication system.

13. The diagnostic interface of claim 12 further comprising an appliance bus interface for communicating with the appliance.

14. The diagnostic interface of claim 12 further comprising a remote service center interface.

15. The diagnostic interface of claim 14 wherein the diagnostic interface gathers appliance statistics to send to a remote service center over the remote service center interface.

16. The diagnostic interface of claim 12 further comprising a user interface to facilitate service diagnostics.

17. The diagnostic interface of claim 12 wherein the appliance comprises a refrigerator.

18. The diagnostic interface of claim 12 wherein the appliance comprises an oven.

19. The diagnostic interface of claim 12 wherein the appliance comprises a heating system.

20. The diagnostic interface of claim 12 wherein the appliance comprises a cooling system.

21. The diagnostic interface of claim 12 wherein the appliance comprises a lighting system.

22. A diagnostic system for provide access to service diagnostics on an appliance, the system comprising:
a diagnostic interface for accepting service diagnostics commands destined for the appliance;
a local area appliance network coupled to the appliance and the diagnostic interface; and
a dedicated appliance controller for receiving and executing the diagnostics commands.

23. The system of claim 22 wherein the local area appliance network comprises a power line carrier network.

24. The system of claim 22 wherein the diagnostic interface comprises a computer.

25. The system of claim 22 wherein the diagnostics interface comprises a laptop computer.

26. The system of claim 22 further comprising a communications interface between the local area appliance network and the dedicated appliance controller.

27. The system of claim 22 further comprising a remote system, the remote system connectable to the diagnostic interface via an Internet connection.

28. The system of claim 22 wherein the dedicated appliance controller is contained within the appliance.
